(19) United States
(12) Patent Application Publication
(10) Pub. No.: US 2025/0346178 A1
(43) Pub. Date: Nov. 13, 2025

(54) PICKUP TRUCK LOAD SUPPORT APPARATUS

(71) Applicant: James Alexander Campbell, Victoria (CA)

(72) Inventor: James Alexander Campbell, Victoria (CA)

(21) Appl. No.: 18/661,726

(22) Filed: May 13, 2024

(51) Int. Cl. B60P 7/08; B60P 7/135

(52) U.S. Cl. CPC B60P 7/0815; B60P 7/135

(57) ABSTRACT

The apparatus includes support member supported on mounting stems that engage stake holes in the truck bed side walls of a pickup truck. Typically, two stake holes are provided on each truck bed side wall near the tailgate and two additional stake holes 16 are provided in the truck bed sidewalls near the cab.

### FIELD OF THE INVENTION

The present invention is generally directed to apparatus for cooperation with a pickup truck or other similar vehicles to improve the capability of the truck to accommodate long loads. Pickup trucks are relatively light-duty trucks having an enclosed cabin and a back end made up of a cargo bed that is enclosed by 3 low walls with no roof. In some cases, racks of this type are referred to as ladder racks. Some prior art embodiments may employ a horizontal bar and supported by two spaced apart vertical legs that engage stake holes at the front and/or the back of the bed of the pickup truck.

Such embodiments having respective front and rear horizontal bars disposed in a virtual substantially single horizontal plane are useful for some applications. A limitation of such designs is the inherent difficulty of the loading long ladders or pipes or other long loads at the elevation at which the horizontal bars are positioned. Many will consider such apparatus aesthetically unpleasant response in addition to the drag implicitly and rear horizontal bar of this kind.

It is impractical to use merely one such horizontal bar positioned near the front of the pickup truck bed in combination with the top of the tailgate because truck manufacturers have designed tailgates to allow only very limited vertical loads being applied to the top of the tailgate. The consequences of exceeding that figure are substantially expensive because of the structure of the tailgate. Tailgates are no longer merely a single piece of sheet metal formed into a tailgate. More precisely, tailgates are complex curves assemblies incorporating various lights, sensors and cameras. Accordingly, carrying a long load on the top of the tailgate is not realistic because of the extraordinary expense that may be incurred.

Some structures for accommodating long loads interfere with placement of Tonneau covers that extended over the bed of the truck. In some cases, such covers have folding rectangular sections. Some load support structures interfere in installation, folding or unfolding of a tonneau cover.

Still another concern in providing suitable apparatus is the need to provide apparatus that is aesthetically satisfactory as well as economical to produce.

The multiple considerations described above must first be recognized by an inventor before conception of a solution. Response From the above, it is therefore seen that there exists a need in the art to overcome the deficiencies and limitations described herein and above.

### SUMMARY OF THE INVENTION

The shortcomings of the prior art are overcome and additional advantages are provided in a support bar assembly for use with an associated elongated pickup truck having a front end and a rear end, the rear end including having a cargo bed bordered by 1^{st} and 2^{nd} opposed elongated sidewalls extending parallel to the direction of elongation of the pickup truck and each side wall including a stake hole proximate the rearmost part thereof which includes 1^{st} and 2^{nd} stems respectively dimensioned and configured for engagement with the associated stake holes, 1^{st} and 2^{nd} side plates respectively attached to the 1^{st} and 2^{nd} stems, a support bar extending between the 1^{st} and 2^{nd} side plates, the support bar is disposed further from the front end of the truck than the stake holes that are engaged by the stems.

In some embodiments the side plates each include 1^{st} and 2^{nd} side edges that are mutually parallel. The 1^{st} and 2^{nd} side edges maybe disposed at an acute angle with respect to the direction of elongation of the pickup truck.

The apparatus may further include a stem having screw threads in a stem for engagement of a threaded member to prevent theft of the apparatus.

Additional features and advantages are realized through the techniques of the present invention. Other embodiments and aspects of the invention are described in detail herein and are considered a part of the claimed invention.

### BRIEF DESCRIPTION OF DRAWINGS

The subject matter which is regarded as the invention is particularly pointed out and distinctly claimed in the concluding portion of the specification. Although specific features of various exemplary embodiments of the invention may be shown in some drawings and not in others, this is for convenience only. In accordance with the principles of the invention, any feature of a drawing maybe referenced and/or claimed in combination with any feature of any other drawing.

The invention, however, both as to organization and method of practice, together with the further objects and advantages thereof, may best be understood by reference to the following description taken in connection with the accompanying drawings in which:

FIG. 1 is a view of a first embodiment of the support apparatus 10 in accordance with present invention installed on the two rear stake holes of a pickup truck,

FIG. 2 is a fragmentary illustration of the rear end of a pickup truck showing the relationship between the first embodiment of the load support apparatus and the structure of the pickup truck adjacent to the tail gate and further illustrates the functionality of the load support apparatus with the tailgate open or closed,

FIG. 3 is a view of the first embodiment of the load support apparatus before it is engaged with the pickup truck,

FIG. 4 illustrates a long load being carried by the first embodiment of the load support apparatus as well as a prior art support disposed adjacent to the cab and front stake holes of the pickup truck,

FIG. 5 is a view of a second embodiment of the present invention.

### DETAILED DESCRIPTION OF THE INVENTION

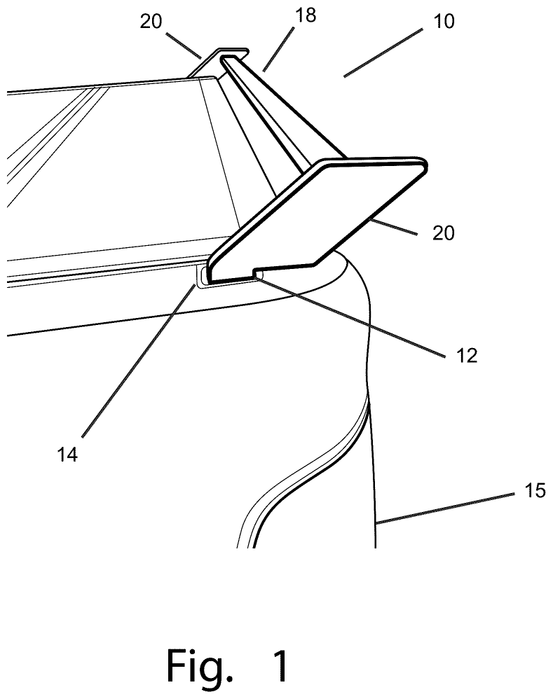

Referring now to FIGS. 1-4 there is shown a first embodiment of the load support apparatus 10 in accordance with the present invention. The apparatus 10 includes mounting stems 12 that engage stake holes 14 in the truck bed side walls of a pickup truck 15.

Stake holes 14 in the truck bed sidewalls of a truck bed are also known as stake pockets. Typically, two stake holes 16 are provided on each truck bed side wall near the tailgate and two additional stake holes 16 are provided in the truck bed sidewalls near the cab (not shown). The stake holes provide a secure method to mount items like tie-down straps, cargo nets, and even small ladders. In the past, stakes were inserted into these pockets to provide taller bed sides

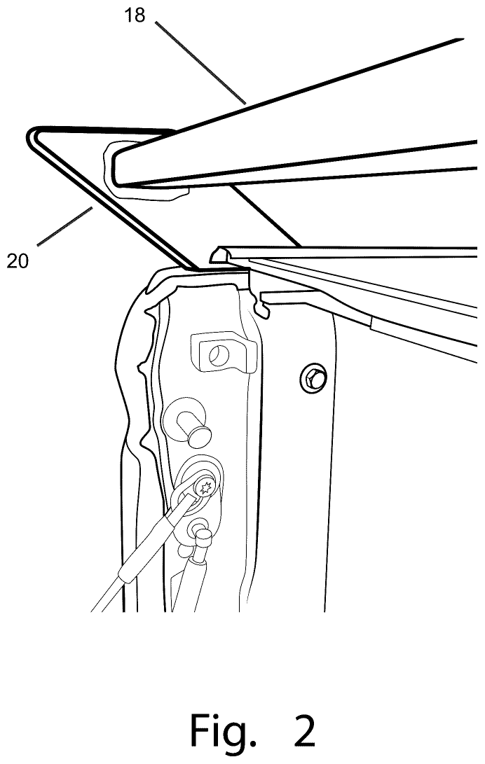

The present apparatus 10 includes a support bar 18 positioned at a higher elevation than the top of the tailgate so that the user can still open and close the tailgate with the load in place as illustrated in FIG. 2. Furthermore, the support bar 18 is disposed aft or behind the two rear stake holes 14 of the pickup truck 16. This construction ensures that no load is imposed on the top of the tailgate as well as ensuring the tonneau cover can be, folded or unfolded without interference with the support bar in accordance with the present invention.

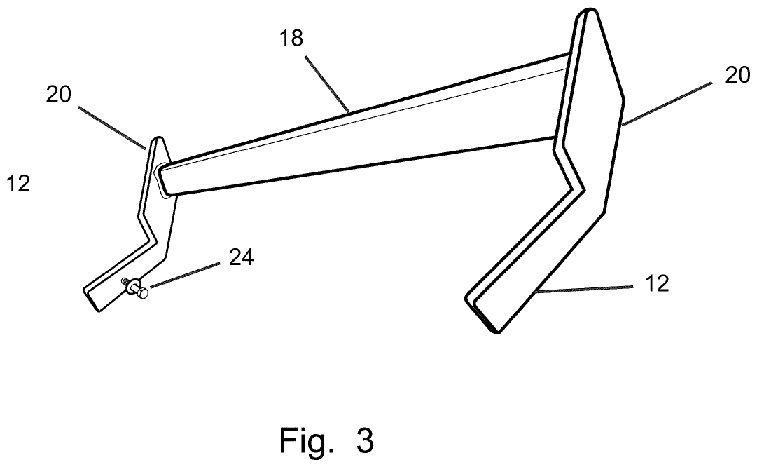

The construction of the load support apparatus 10 is more clearly shown in FIG. 3. More specifically, the full extent of the stems 12, 12 as well as inside plates 20, 20 engaging the bar 18 are shown. A locking bolt and screw threads 24 in the stem 12 selectively allow the user to secure the stem 12 to the truck bed side wall to prevent theft.

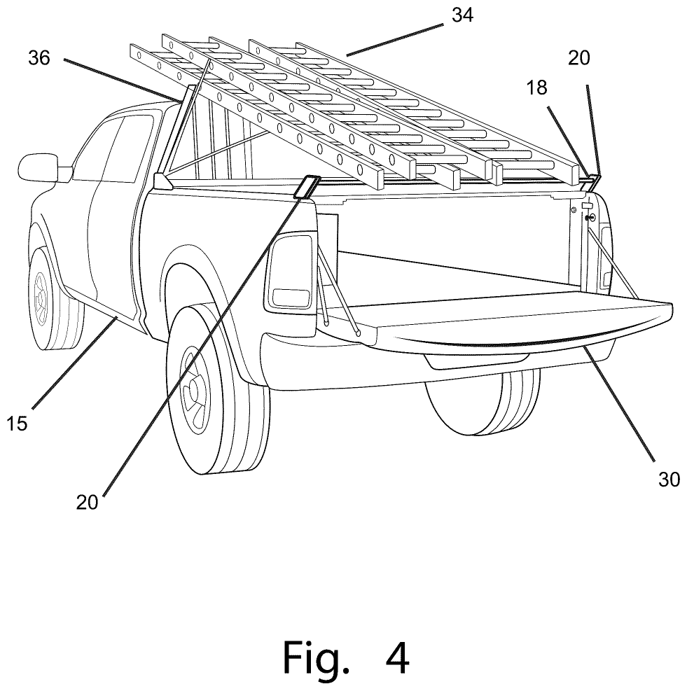

FIG. 4 illustrates a long load, namely multiple ladders 34 supported by a bar 18 supported by side plates 20, 20 in accordance with the present invention as well as a conventional forward support 36 on a truck 15. It will be seen that the position of the bar 18 above the tailgate 30 allows complete access to the bed of the truck concurrently with carrying the ladders 34.

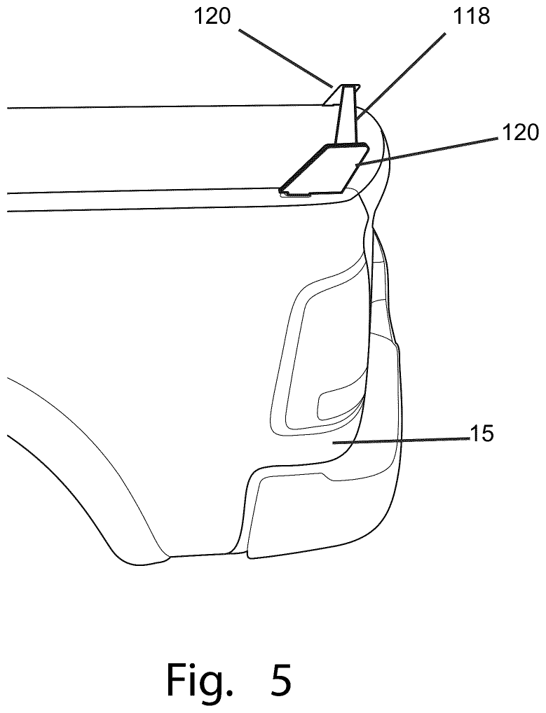

Referring now to FIG. 5 there is shown a 2nd embodiment of the present invention. In this embodiment cooperates with the same truck 16 and uses side plates 120 supporting an. The side plates 120 in this embodiment more closely approach the shape of a trapezoid as opposed to the shape of the side plates 20 having a shape resembles a parallelogram. In both the 1^{st} and 2^{nd} embodiments the respective side plates 20 and 120 respectively positioned support bars 18 and 118 horizontally at an elevation above the top of the tailgate and behind the stake holes that support the respective side plates 20 and 120.

Accordingly, it will be seen that the present apparatus provides an aesthetically pleasing support bar that does not interfere with opening and closing the tailgate for accessing the bed of the truck, avoids possible damage to the tailgate, allows excellent access to tonneau covers mounted between the sidewalls of the bed of the truck including allowing folding of such tonneau covers. Furthermore, the location of the rear support bar at a lower elevation than any front support bar near the cab of the vehicle means that in the case of elongated limber members extending between the front and rear support bars will be less likely to interfere with the operation or movement of a truck on which the apparatus is installed. More specifically, the placement of the rear support bar at a lower elevation than the front support bar reduces the possibility of a free end of an object being carried interfere with the vision of the driver or other interference prejudicial to the operation of the vehicle. In

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

It will be understood that for purposes of description the use of the terms “stem” and “side plate” do not require that the respective parts are distinct from each other. More particularly, the respective parts may be a single piece formed or welded together.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “an imager” should typically be interpreted to mean “at least one imager”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two images,” or “a plurality of images,” without other modifiers, typically means at least two images).

Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A support bar assembly for use with an associated elongated pickup truck having a front end and a rear end, the rear end including having a cargo bed bordered by 1st and 2nd opposed elongated sidewalls extending parallel to the direction of elongation of the pickup truck and each side wall including a stake hole proximate rearmost part thereof which comprises:
1^{st} and 2^{nd} stems respectively dimensioned and configured for engagement with the associated stake holes, 1^{st} and 2^{nd} side plates respectively attached to said 1^{st} and 2^{nd} stems, a support bar extending between said 1^{st} and 2^{nd} side plates, said support bar being disposed further from the front end of the truck than the stake holes that are engaged by said stems.

2. The apparatus as described in claim 1 wherein said side plates each include 1^{st} and 2^{nd} side edges that are mutually parallel.

3. The apparatus as described in claim 2 wherein said 1^{st} and 2^{nd} side edges are disposed at an acute angle with respect to the direction of elongation of the pickup truck.

4. The apparatus as described in claim 1 further including a stem having screw threads in a stem for engagement of a threaded member to prevent theft of the apparatus.

5. The apparatus as described in claim 1 wherein associated elongated pickup truck has a tailgate and said support bar being disposed above said tailgate.
